(19) United States
(12) Patent Application Publication
(10) Pub. No.: US 2021/0182214 A1
(43) Pub. Date: Jun. 17, 2021

(54) PREFETCH LEVEL DEMOTION

(71) Applicant: Advanced Micro Devices, Inc., Santa Clara, CA (US)

(72) Inventor: Paul Moyer, Fort Collins, CO (US)

(21) Appl. No.: 16/718,162

(22) Filed: Dec. 17, 2019

(51) Int. Cl. G06F 12/122; G06F 12/0897; G06F 12/0862

(52) U.S. Cl. CPC G06F 12/122; G06F 12/0897; G06F 2212/601; G06F 2212/602; G06F 12/0862

(57) ABSTRACT

A method includes recording a first set of cache performance metrics for a target cache, for each prefetch request of a plurality of prefetch requests received at the target cache, determining based on the first set of cache performance metrics a relative priority of the prefetch request relative to a threshold priority level for the target cache, for each low-priority prefetch request of the plurality of prefetch requests, redirecting the low-priority prefetch request to a first lower-level cache in response to determining that a priority of the low-priority prefetch request is less than the threshold priority level for the target cache, and for each high-priority prefetch request of the plurality of prefetch requests, storing prefetch data in the target cache according to the high-priority prefetch request in response to determining that a priority of the high-priority prefetch request is greater than the threshold priority level for the target cache.

### BACKGROUND

A processor in a modern computing system can typically operate much more quickly than a main memory that stores instructions or other data used by the processor. Thus, in many cases a smaller and faster cache memory is used in conjunction with the main memory to provide quick access to the instructions or data. Prefetching of data to the cache occurs when the processor requests data to be stored in the cache before the data is actually needed. Then, when the data is needed, it can be retrieved from the cache without incurring the additional latency of requesting it from the main memory.

Since most programs are executed sequentially or exhibit other regular patterns of execution, instructions or other data can be fetched in program order or according to other identified patterns in the memory access stream. However, prefetching incorrect data, or prefetching data at an inappropriate time can reduce the overall benefit provided by the prefetching implementation.

### BRIEF DESCRIPTION OF THE DRAWINGS

The present disclosure is illustrated by way of example, and not by way of limitation, in the figures of the accompanying drawings.

FIG. 1 illustrates a computing system, according to an embodiment.

FIG. 2 illustrates a memory hierarchy in a computing system, according to an embodiment.

FIG. 3 illustrates components of a cache, according to an embodiment.

FIG. 4 illustrates information stored in cache tags, according to an embodiment.

FIG. 5 illustrates demotion of prefetches in a cache hierarchy, according to an embodiment.

FIG. 6 is a flow diagram illustrating a prefetching process, according to an embodiment.

### DETAILED DESCRIPTION

The following description sets forth numerous specific details such as examples of specific systems, components, methods, and so forth, in order to provide a good understanding of the embodiments. It will be apparent to one skilled in the art, however, that at least some embodiments may be practiced without these specific details. In other instances, well-known components or methods are not described in detail or are presented in a simple block diagram format in order to avoid unnecessarily obscuring the embodiments. Thus, the specific details set forth are merely exemplary. Particular implementations may vary from these exemplary details and still be contemplated to be within the scope of the embodiments.

In a computing system that includes multiple levels of cache (e.g., L1, L2, and L3), prefetches of data or instructions are targeted toward a particular one of the cache levels by a hardware prefetcher or software, such as a user application. For example, a computing system including multiple levels of cache also includes a hardware prefetcher for each of the cache levels that monitors memory access streams and determines which data to fetch from main memory into its associated cache level or to a lower-level (higher-numbered) cache. In addition, prefetches can be generated from instructions (e.g., as provided in the x86 instruction set) for targeting a given cache level; such instructions are generated by a compiler using a heuristic to predict which items should be prefetched at runtime. Thus, both hardware and software prefetch mechanisms target a particular level of cache that is selected without considering the availability of resources in the targeted cache.

In some cases, the resources of the targeted level of cache are over-utilized, and the prefetch is more appropriately targeted to a lower cache level. Also, prefetching to the cache level targeted by the hardware or software prefetcher does not always result in the lowest latency for the amount of low-level cache capacity consumed; prefetching to a lower level (i.e., higher-numbered) cache can in some cases have a better capacity/latency impact, especially if a substantial number of prefetches are determined to be inaccurate or are being performed too early. Prefetches sent to an inappropriately targeted cache level can cause increased latency for the prefetched cache line or for other cache lines (e.g., cache lines evicted due to early or inaccurate prefetches) at that level, due to increased pressure on the cache line capacity and resource availability of the targeted cache level.

In one embodiment, each level in the cache hierarchy includes a cache controller having logic for demoting prefetches to a lower (i.e., higher numbered and higher capacity) cache level. For example, prefetches initially targeting the L2 cache are demoted to the L3 cache when certain conditions are met indicating that the prefetch should be given a lower priority than existing data in the initially targeted L2 cache.

In one embodiment, the cache controller for a targeted cache level demotes a prefetch to a lower cache level if the miss request buffers and/or victim buffers of the target cache are full or nearly full, or if a number of misses outstanding to a particular cache index exceeds a threshold number (in implementations where cache misses are tracked by the cache tags themselves).

In one embodiment, the cache controller tracks prefetch usage metrics based on the usage by demand operations of previously prefetched data or instructions. Upon determining based on these prefetch metrics that prior prefetches have been either inaccurate (i.e., are evicted from the cache before being demanded) or untimely (i.e., the prefetched information is demanded too late), the cache controller lowers the priority for some or all prefetches incoming to that target cache level. Accordingly, the lower priority prefetches do not cause capacity evictions of higher priority cache lines in the target cache.

In one embodiment, the cache controller identifies high priority cache lines according to a cache replacement policy. For example, high priority cache lines are frequently reused, or are reused by operations that are more critical than others, such as instruction fetches, translation lookaside buffer (TLB) fetches, loads/stores which are in the critical path, etc. If the proportion of high priority cache lines exceeds a threshold, then demoting prefetches to the next lower level of cache allows the high priority ‘hot’ cache lines to remain undisturbed in the target cache.

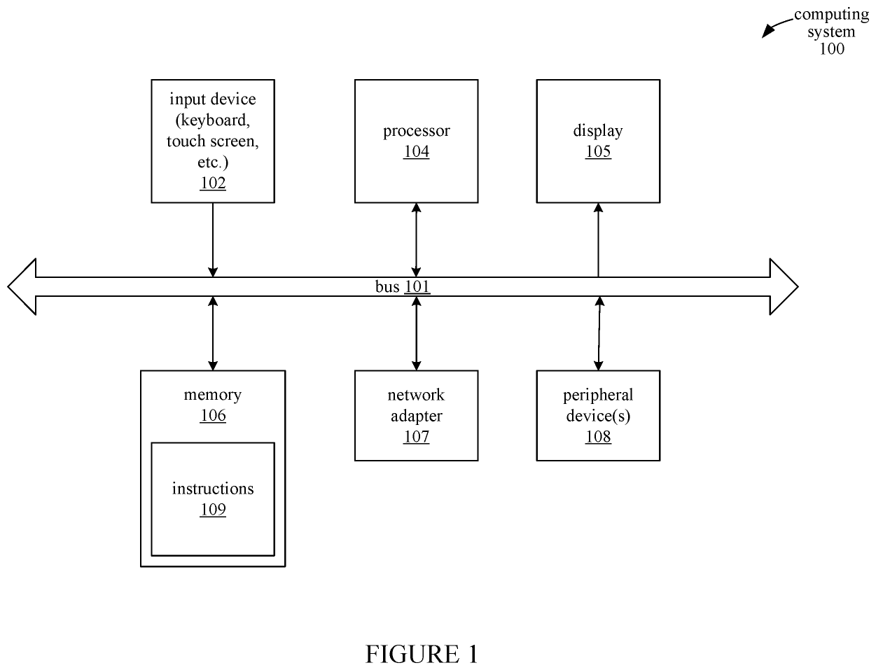

FIG. 1 illustrates an embodiment of a computing system 100 implementing a prefetch demotion mechanism. In general, the computing system 100 is embodied as any of a number of different types of devices, including but not limited to a laptop or desktop computer, mobile device, server, network switch or router, etc. The computing system 100 includes a number of hardware resources, including components 102-108, which communicate with each other through a bus 101. In computing system 100, each of the components 102-108 is capable of communicating with any of the other components 102-108 either directly through the bus 101, or via one or more of the other components 102-108. The components 101-108 in computing system 100 are contained within a single physical enclosure, such as a laptop or desktop chassis, or a mobile phone casing. In alternative embodiments, some of the components of computing system 100 are embodied as external peripheral devices such that the entire computing system 100 does not reside within a single physical enclosure.

The computing system 100 also includes user interface devices for receiving information from or providing information to a user. Specifically, the computing system 100 includes an input device 102, such as a keyboard, mouse, touch-screen, or other device for receiving information from the user. The computing system 100 displays information to the user via a display 105, such as a monitor, light-emitting diode (LED) display, liquid crystal display, or other output device.

Computing system 100 additionally includes a network adapter 107 for transmitting and receiving data over a wired or wireless network. Computing system 100 also includes one or more peripheral devices 108. The peripheral devices 108 may include mass storage devices, location detection devices, sensors, input devices, or other types of devices used by the computing system 100. Memory system 106 includes memory devices used by the computing system 100, such as random-access memory (RAM) modules, read-only memory (ROM) modules, hard disks, and other non-transitory computer-readable media.

Computing system 100 includes a processing unit 104. In one embodiment, the processing unit 104 includes multiple processing cores that reside on a common integrated circuit substrate. The processing unit 104 receives and executes instructions 109 that are stored in a memory system 106. At least a portion of the instructions 109 defines an application including instructions that are executable by the processing unit 104.

Some embodiments of computing system 100 may include fewer or more components than the embodiment as illustrated in FIG. 1. For example, certain embodiments are implemented without any display 105 or input devices 102. Other embodiments have more than one of a particular component; for example, an embodiment of computing system 100 could have multiple processing units 104, buses 101, network adapters 107, memory systems 106, etc.

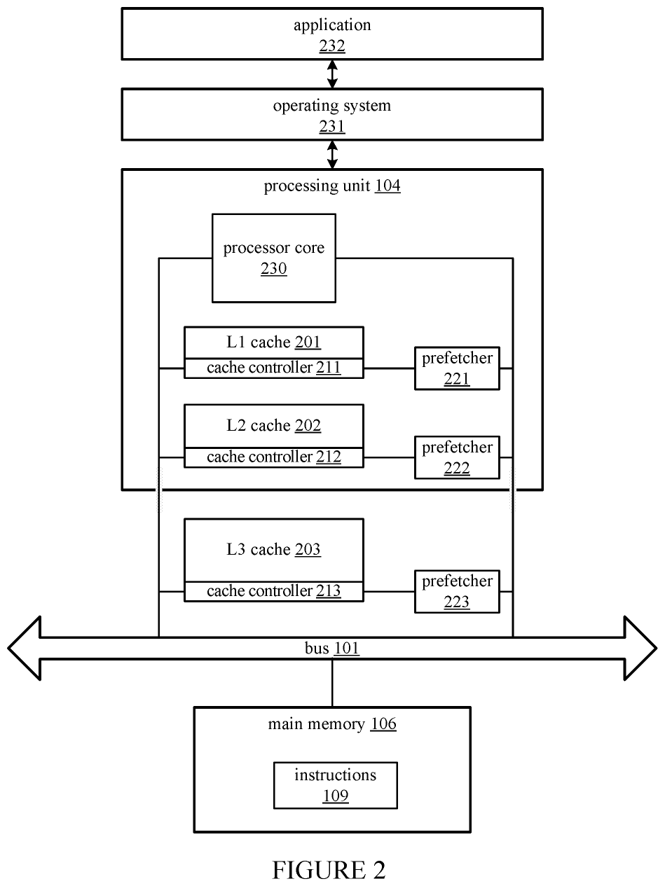

FIG. 2 illustrates a cache hierarchy of a processing unit, according to an embodiment. The processing unit 104 includes a cache hierarchy that includes an L1 cache 201, an L2 cache 202, and an L3 cache 203. Other devices, such as the processor core 230, interface with these caches 201-203 via cache controllers 211-213, which control the caches 201-203, respectively. The processor core 230 runs an operating system 231 and a user application 232 by executing instructions 109. In the cache hierarchy, the highest L1 cache 201 is the fastest and smallest capacity cache in the hierarchy. The successive lower caches L2 202 and L3 203 are increasingly slower (i.e., higher latency) and/or larger in capacity.

Hardware prefetchers 221-223 are associated with cache levels 201-203, respectively, and generate prefetch requests for their associated cache levels or cache levels lower than their associated cache levels. The prefetch requests support the execution of application 232 by loading a targeted cache with data or instructions that will be used by the application 232 before it is demanded. Accordingly, the hardware prefetchers 221-223 determine which data or instructions to prefetch by performing branch prediction for the application 232 and/or by predicting future memory accesses by the application 232 based on a pattern of prior memory accesses by the application 232. Prefetch requests are also generated by the processor core 230 executing instructions of the application 232. For example, the application 232 instructions can include explicit instructions to prefetch certain data or instructions to a particular specified level of cache.

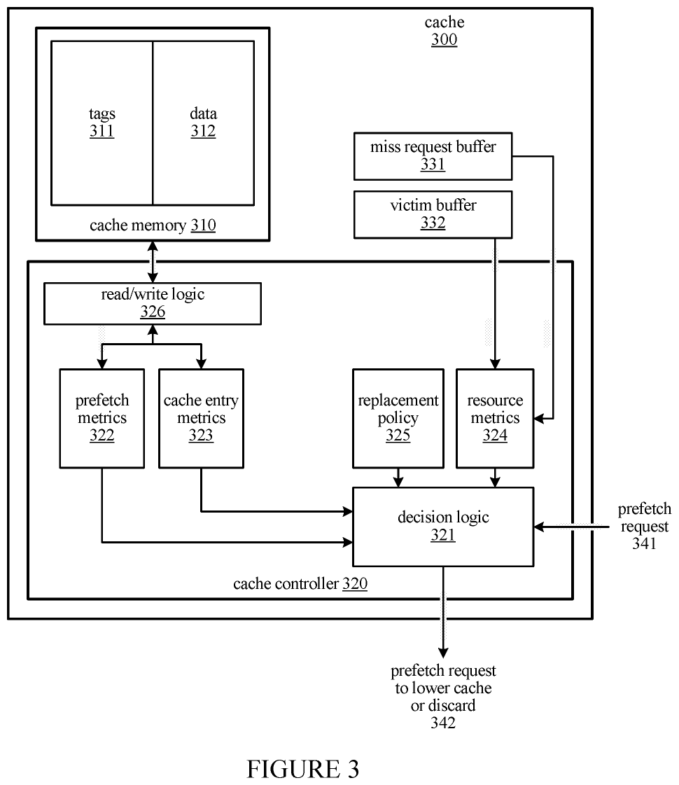

FIG. 3 illustrates circuit components in a cache 300, according to an embodiment. Each of the caches 201-203 includes similar components and functions in a similar manner as cache 300. Cache 300 includes a memory 310 that stores an array of cache lines, each associating one or more of the tags 311 with a portion of the data 312 in the cache line. The tags 311 include information about the data in their associated cache lines, such as whether the data was from a prefetch, the source of the prefetch (e.g., hardware prefetcher, application, etc.), the access frequency of the data, the type of operation that uses the data, etc. The cache controller 320 includes read/write logic 326 for reading and writing tags 311 and data 312 in the memory 310.

The cache 300 contains monitoring circuitry, including prefetch metrics 322, cache entry metrics 323, and resource metrics 324 modules, which record performance metrics for the cache 300. The prefetch metrics module 322 measures metrics indicating prefetch accuracy and timeliness based on information in the tags 311. In one embodiment, when a prefetch request is accepted by the cache 300, the controller 320 updates a tag associated with the cache line (e.g., by asserting a bit) indicating that the cache line contains prefetched data that has not been used. When the prefetched data is subsequently demanded by a higher-level cache or by the processor 230, the tag is updated (e.g., by clearing the bit) to reflect that fact that the data was demanded. Over time, the prefetch metrics module 322 tracks the proportion of used prefetched cache lines for which a demand request is received to unused prefetched cache lines that are evicted from the cache 300 before being demanded. A high proportion of unused prefetches indicates that prefetches are inaccurate, as a result of branch misprediction or other factors.

In one embodiment, the source of the original prefetch request is also tracked in the tags 311; for example, the tags 311 indicate whether the prefetch request arrived from a hardware prefetcher of the targeted cache, a hardware prefetcher of a higher-level cache, or processor 230 executing application instructions. In one embodiment, a thread identifier or other information identifying the application is added to the tag to identify the specific thread or process that initiated the prefetch request. In one embodiment, the system 100 includes different types of hardware prefetchers (that generate prefetch requests based on observing different types of patterns), which are also tracked as different prefetch sources. The controller 320 is then able to independently track prefetch accuracy and timeliness for prefetches originating from each of the different prefetch sources.

The prefetch metrics module 322 also tracks when the prefetched data is eventually demanded, but at a lower cache level rather than the initially targeted cache level. This tends to indicate that the data was prefetched too early relative to other data targeting the same cache. In this case, it is less computationally expensive for the prefetch to have targeted the lower-level cache initially. Accordingly, when prefetches are inaccurate or untimely, the prefetch requests are demoted to the next lower cache level to avoid polluting the initially targeted cache with prefetch data that is not likely to be demanded from that cache level.

The cache entry metrics module 323 records metrics for the entries (e.g., cache lines) in the memory 310, such as an access frequency for each cache line, an operation time associated with the cache line, etc. In one embodiment, the metrics are recorded in the tags 311. The cache entry metrics are used to determine a priority level for the cache entries. Cache lines that are accessed frequently or demanded by higher priority operations (e.g., instruction fetches, TLB fetches, loads/stores which are in the critical path, etc.) are given a higher priority relative to prefetches with a lower likelihood of being demanded.

The resource metrics module 324 monitors the miss request buffer 331 and the victim buffer 332 of the cache 300 for indications of cache resource over-utilization, such as high cache miss traffic. The miss request buffer 331 stores lines missing from the cache until they can be transferred into the cache memory 310, while the victim buffer 332 stores lines evicted from the cache memory 310 as a result of a cache miss. Thus, when the cache 300 is experiencing a high miss rate, the demand for space in the miss request buffer 331 and victim buffer 332 increases. When this occurs, the cache resources are over-utilized; thus, lower-priority prefetches are demoted to a lower-level, higher capacity cache in the hierarchy.

The decision logic 321 determines based on the cache performance metrics tracked by the monitoring circuitry whether a prefetch request 341 will be accepted at the cache 300 or demoted to a lower-level cache. The prefetch request 341 is received at the decision logic 321 in the cache controller 320 and, in response to receiving the prefetch request 341, the decision logic 321 determines a priority of the prefetch relative to the priority of the existing entries in the cache memory 310. In one embodiment, the existing entries include entries currently in the cache memory 310, as well as entries that are designated for placement in the cache (e.g., entries existing in the miss request buffers that are not yet in the cache memory 310). In one embodiment, the relative priority is a difference between a priority level of the prefetch and a priority level of one or more existing entries in the cache memory 310. In other words, the relative priority for the prefetch request indicates whether the priority of the prefetch request is higher or lower than the threshold priority level for the target cache. In one embodiment, the threshold priority level for the cache is determined based on the lowest priority level of an existing cache line that is a candidate for eviction by the prefetch. If the priority of the incoming prefetch is not greater than the priority of any existing cache entry, then the prefetch is demoted to the next lower level of cache.

The decision logic 321 determines the priority of the prefetch request 341 and the threshold priority level of the existing cache lines based on a cache replacement policy 325 and the various metrics tracked by the modules 322-324. The decision logic 321 thus determines which cache lines are the most important and should be kept in the cache 300.

The replacement policy 325 defines a set of rules for identifying the lowest priority cache lines to evict when a new cache line is being written to the cache memory 310. For example, a least frequently used (LFU) replacement policy designates the least frequently used cache lines for eviction from the cache 300 before more frequently used cache lines are evicted, while a least recently used (LRU) replacement policy evicts the least recently used cache lines prior to evicting more recently used cache lines. In one embodiment, the cache implements a re-reference interval prediction (RRIP) replacement policy, which predicts which cache lines are likely to be reused in the near future.

Accordingly, the decision logic 321 determines the priority level of the existing cache lines in the memory 310 based on the replacement policy. In one embodiment, cache lines that are more likely to be reused are assigned a higher priority. If a priority level of an incoming prefetch request is not greater than the priority level of any existing cache line, then the prefetch request is demoted to the next lower level of cache to avoid evicting any of the higher priority existing cache lines. In alternative embodiments, mechanisms other than a cache replacement policy are used by the decision logic 321 to determine the relative priority of existing cache lines, and as a basis for determining whether to demote or accept incoming prefetch requests.

In addition to frequency or recency of reuse, the priority of an existing cache line is also determined based on the type of operation that is reusing the cache line. In one embodiment, the type of operation demanding the cache line is recorded in a tag of the cache line. When a prefetch request 341 is received, the decision logic 321 assigns a high priority to cache lines that are used by high priority operations. For example, a cache line that is used by a translation lookaside buffer (TLB) walker or a load/store operation in the critical path of the application 232 is given a higher priority level than, for example, a cache line used by an operation not in the critical path. Incoming prefetches are therefore demoted to avoid evicting cache lines utilized by such high priority operations.

In addition to the cache entry metrics 323, the decision logic 321 also determines whether to demote the incoming prefetch request 341 based on the resource metrics 324. In one embodiment, when the miss request buffer 331 and/or victim buffer 332 are each full or are filled beyond an occupancy threshold, then the decision logic 321 demotes all prefetches to the next lower-level cache. In alternative embodiments, the decision logic 321 accepts a subset of higher priority prefetch requests instead of demoting all of the prefetches.

The decision logic 321 determines a priority level for the prefetch request 341 based on the prefetch metrics 322. The prefetch metrics 322 indicate whether prior prefetches have been accurate and timely. If the prior prefetches have not been accurate or have not been timely, then the decision logic 321 assigns a lower priority to the incoming prefetch request 341. In one embodiment, prefetch accuracy and timeliness is tracked separately for each source of prefetches (e.g., a hardware prefetcher, a processor executing application instructions, etc.), so that inaccurate or untimely prefetch requests issued by one source do not affect the priority of prefetch requests issued from a different source. The decision logic 321 assigns a higher priority to prefetch requests originating from a source that has previously generated more accurate and timely prefetches, while assigning a lower priority to prefetch requests originating from a source that has generated inaccurate and/or untimely prefetch requests. In one embodiment, the decision logic 321 assigns a higher priority to prefetch requests for data or instructions that will be used by high priority operations (e.g., operations in the critical path, etc.).

For each prefetch request received at the cache 300, such as prefetch request 341, the decision logic 321 determines a relative priority for the prefetch request by comparing the priority of the prefetch request with the priority of the existing cache lines. If the prefetch request has a lower priority than any of the cache lines already in the cache memory 310, then the decision logic 321 demotes the prefetch request 341 to a lower cache level by redirecting a copy of the prefetch request 342 to the lower cache level. If the cache 300 is already the lowest level of cache in the cache hierarchy, the prefetch request 342 is discarded instead of being redirected to a lower level cache.

In one embodiment, the decision logic 321 redirects the prefetch request 342 to the next lower level cache in the hierarchy by default (e.g., a L2 cache demotes a low priority prefetch to the L3 cache). In an alternative embodiment, the decision logic 321 selects any of multiple lower cache levels to receive the demoted prefetch request. Upon receiving the demoted prefetch request 342 at the lower level cache, another decision logic in the lower level cache similarly determines based on its own prefetch, cache entry, and resource metrics whether to accept the prefetch request 342 or demote the request 342 again to the next lower level cache.

For each prefetch request 341 that is determined by the decision logic 321 to have a higher priority than the threshold priority of the receiving cache 300 (e.g., from the lowest priority cache line), the decision logic 321 accepts the prefetch request 341 by evicting the lowest priority cache line and storing the prefetched data in its memory 310 as specified in the prefetch request 341. For tracking the accuracy and timeliness of the incoming prefetch, a bit is set in the tags 311 indicating that the data is from a prefetch. If prefetch accuracy and timeliness is tracked for each prefetch source, then the source of the prefetch request 341 is also recorded in the tags 311.

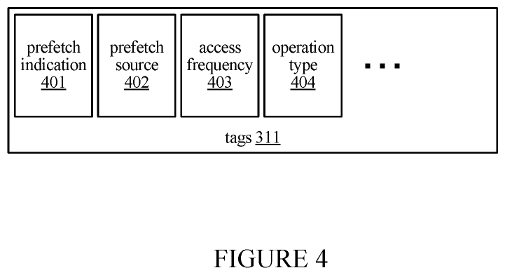

FIG. 4 illustrates information that is stored in the tags 311 for each cache line in the cache memory 310, according to an embodiment. The tags 311 include a prefetch indication 401, a prefetch source 402, an access frequency 403, and an operation type 404, among others. The prefetch indication 401 is implemented as a single bit that is asserted when the associated cache line contains data that was prefetched, and is deasserted otherwise. The prefetch source 402 indicates a source of the prefetch request when the data in the cache line is prefetched data, and can include information such as a thread identifier, device identifier (e.g., for a hardware prefetcher), and/or cache level identifier for prefetches originating from the hardware prefetcher of another cache level. The prefetch source 402 also indicates whether the prefetch request was demoted from a higher cache level. The access frequency 403 indicates how often the data in the associated cache line was demanded over a period of accesses to the cache or cache index. The operation type 404 indicates the type of operation or operations that are demanding the data in the associated cache line. The tags 401-404 are updated by the cache controller 320 when cached data is accessed (i.e., written or demanded), and are used by the decision logic 321 to determine priorities of incoming prefetch requests and existing cache lines, as previously described.

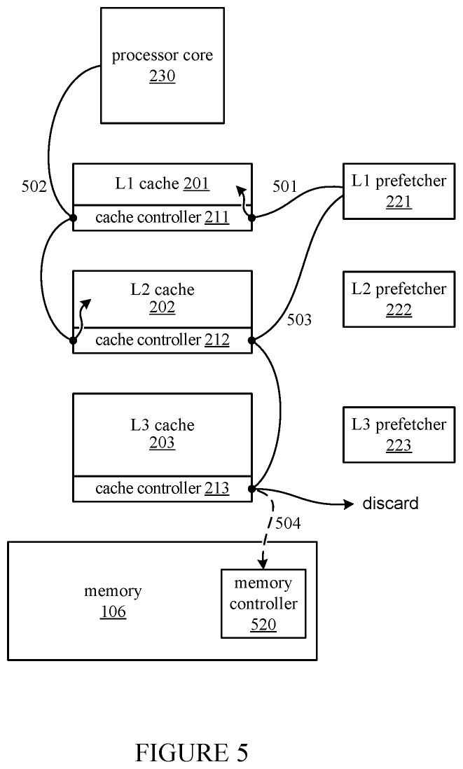

FIG. 5 illustrates a prefetch demotion mechanism operating on a number of prefetch requests received at different levels in a cache hierarchy, according to an embodiment. FIG. 5 illustrates the processor core 230 and a cache hierarchy including L1 cache 201, L2 cache 202, and L3 cache 203, and their respective cache controllers 211-213, and prefetchers 221-223.

A first prefetch request 501 is generated by the hardware prefetcher 221 at the L1 cache level. The prefetch request 501 is targeted at the L1 cache 201, and is received at the cache controller 211. The decision logic in the cache controller 211 determines that the prefetch request 501 has a higher priority than at least one of its existing cache lines, and thus evicts the lowest priority cache line to accept the prefetched data.

Prefetch request 502 is issued from the processor core 230 as a result of the processor core 230 executing a prefetch instruction of application 232. At the L1 cache level 201, the decision logic in cache controller 211 determines that the priority of the prefetch request 502 is less than the priority of the lowest priority cache line in the cache 201, and therefore demotes the prefetch 502 to the L2 cache level 202. Alternatively, the prefetch 502 can be demoted to the L2 cache level 202 if the resources of the L1 cache 201 are over-utilized due to a high miss rate or other reasons. The decision logic in the L2 cache controller 212 determines that the prefetch request 502 has a relatively higher priority than the lowest priority cache line in the L2 cache 202, and the prefetch request 502 is accepted in the L2 cache 202.

In one embodiment, the hardware prefetcher for a particular cache level is able to generate prefetch requests targeting lower cache levels in the hierarchy. Accordingly, the L1 prefetcher 221 generates a prefetch request 503 directed at the L2 cache level 202. The decision logic in the cache controller 212 determines that the prefetch request 503 has a lower priority than any of the existing cache lines in the L2 cache 202. In response, the decision logic demotes the prefetch request 503 to the next lower cache level L3 203. At the L3 cache level 203, the decision logic in the cache controller 213 determines based on its own cache performance metrics that the priority of the prefetch request 503 is also lower than any of its existing cache lines. Since the L3 cache 203 is the lowest cache level in the hierarchy, the prefetch request 503 is discarded.

In one embodiment, the L3 cache controller 213 additionally transmits an indication 504 that the prefetch request 503 was discarded to the memory controller 520 of the main memory 106 where the data of the discarded prefetch 503 resides. In response to receiving the indication 504, the memory controller 520 prepares to read the prefetch data specified by the discarded prefetch 503 in anticipation of an imminent demand request for the attempted prefetch data. For example, the memory controller 520 initializes an access of the memory containing the data by opening the memory page containing the data so that the data can be read with lower latency when it is demanded.

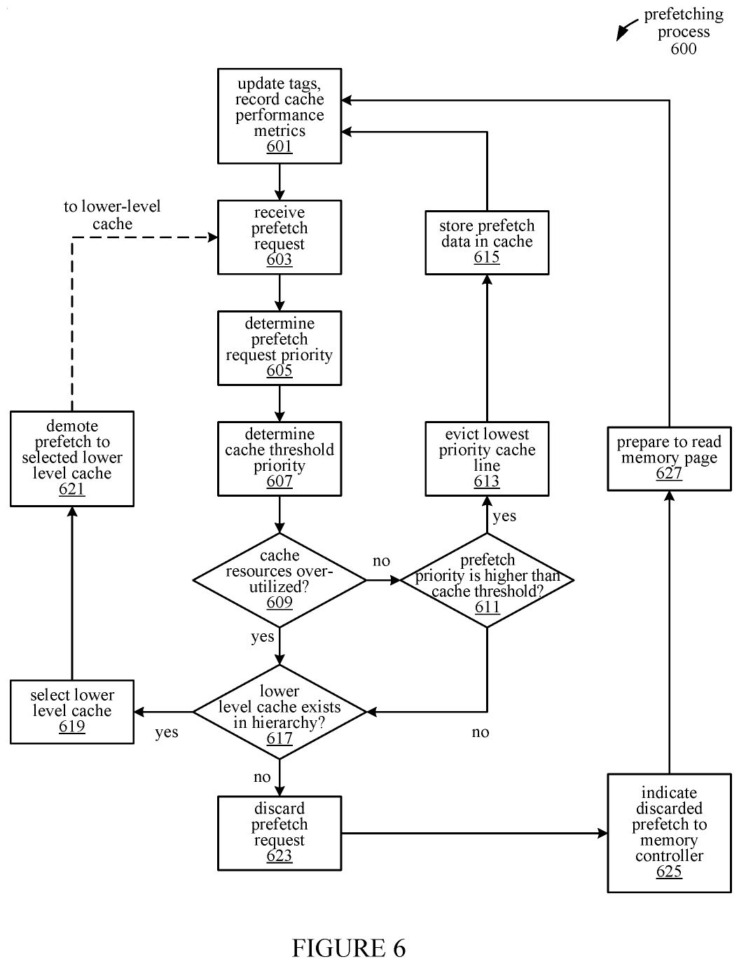

FIG. 6 is a flow diagram illustrating a prefetching process 600, according to an embodiment. The prefetching process 600 is performed by components in the computing system 100, including the caches 201-203 (represented in FIG. 3 as cache 300), cache controllers 211-213 (i.e., cache controller 320), processor core 230, memory controller 520, etc. At block 601, the cache controller 320 updates tags 311 and records cache performance metrics, such as the prefetch metrics 322, cache entry metrics 323, and resource metrics 324. The metrics are recorded in the tags 311 and/or registers and counters in the cache controller 320.

The cache controller 320 of the cache 300 receives a prefetch request 341 at block 603. The prefetch request 341 is received from a hardware prefetcher of the cache 300, a hardware prefetcher of a higher-level cache, or the processor 230 in accord with an explicit prefetch instruction in the application 232.

At block 605, the decision logic 321 determines a priority of the prefetch request 341 based on one or more of the prefetch accuracy metrics 322, which includes a proportion of unused prefetched entries to used prefetched entries. Unused prefetched entries include prefetched data that was evicted from the cache 300 before it was demanded, while used prefetched entries include prefetched data that was demanded from the cache 300. The decision logic 321 assigns a higher priority to the prefetch request 341 corresponding to a higher proportion of used prefetched entries, which indicates that prefetches are accurate and timely. In one embodiment, prefetch accuracy and timeliness is tracked independently for each source of prefetch requests, such as hardware prefetchers for the same level or a higher level cache (including demoted prefetches), the application, etc.

At block 607, the decision logic 321 determines a threshold priority for the cache 300 based on the cache entry metrics 323 and the replacement policy 325. In one embodiment, the priority level of a cache entry is increased corresponding to an access frequency of the entry, an access recency of the entry, an operation type associated with the entry, and/or other factors as defined in the replacement policy 325.

At block 609, if the resources of cache 300 are not over-utilized, then the process 600 continues at block 611. At block 611, the decision logic 321 determines, based on the cache performance metrics, a relative priority for the prefetch request 341. In one embodiment, the relative priority is the difference between the priority level of the prefetch and the threshold priority for the targeted cache level. If the prefetch priority is higher than the cache threshold priority (e.g., the lowest priority entry in the cache 300), then the lowest priority cache entry is evicted at block 613, and the prefetch data for the prefetch request 341 is stored in the cache memory.

The tags 311 are updated at block 601, and updated cache performance metrics are recorded. For example, since a new cache line was written containing the prefetch data, a bit is asserted in the tags for the new cache line to indicate that the data is prefetched data. As another example, if the data that was evicted at block 613 was unused prefetched data, then the prefetch accuracy metric (e.g., a ratio of used to unused prefetched entries) is updated for the source that originally requested prefetching of the evicted data. In addition, if any previously prefetched data was demanded or any unused prefetched data was evicted since the last update 601, the prefetch accuracy metrics are updated. By the operation of blocks 603-615, a subset of the prefetch requests received by the cache controller that are high-priority prefetch requests (i.e., having a higher priority than the cache threshold priority) are accepted, and cause prefetched data to be stored in the cache memory 300.

At block 609, if the cache resources are over-utilized, then the process 600 continues at block 617. The over-utilization of cache resources is indicated by cache performance metrics including a victim buffer occupancy metric and a miss request buffer occupancy metric. The victim buffer occupancy metric represents the amount of used capacity in the victim buffer of the target cache. The miss request buffer occupancy metric represents the amount of used capacity in the miss request buffer of the target cache. In one embodiment, when either the victim buffer occupancy metric or the miss request buffer occupancy metric exceeds a respective threshold, then the cache resources are considered over-utilized such that the process 600 continues from block 609 to block 617.

Block 617 is also reached when at block 611, the prefetch priority is not higher than the cache threshold priority. This is true when every cache line already in the cache memory 310 has a higher priority than the prefetch request 341. In this case, none of the existing higher-priority cache lines is evicted, and the relatively lower-priority prefetch is demoted instead.

At block 617, if one or more lower cache levels exist in the cache hierarchy of the target cache 300, then the decision logic 321 selects one of the lower cache levels at block 619 to receive the demoted prefetch request 342. In one embodiment, the decision logic 321 automatically selects the next lower cache level (e.g., a decision logic in the L1 cache 201 selects the L2 cache 202 to receive the demoted prefetch request). In alternative embodiments, the decision logic does not necessarily select the immediate next lower cache (e.g., the L1 cache 201 selects the L3 cache 203 to receive the demoted prefetch request). At block 621, the decision logic 321 demotes the prefetch request 342 by redirecting it to the selected lower level cache. By the operation of blocks 609 and 617-621, prefetch requests targeting the cache 300 while the cache resources are over-utilized are demoted to a lower-level cache.

In an alternative embodiment, the cache resource utilization level is used to set the threshold priority level of the cache at block 607, and then the process 600 continues from block 607 to block 611. The decision logic 321 at block 607 increases the threshold priority level for the existing cache entries in proportion with increased utilization of cache resources, thus limiting the number of prefetches that are accepted into the cache 300 via block 611 when resource utilization is high.

At block 603, the demoted prefetch request 342 is received at the lower-level cache. The lower-level cache similarly performs the process 600 for the received prefetch request, and accepts or demotes the prefetch request based on priorities determined according to its own cache performance metrics. That is, if the previously demoted prefetch request has a higher priority than the cache threshold priority of the lower-level cache, then the prefetch data is accepted in the lower-level cache according to the low-priority prefetch request, as provided at block 615.

Low priority prefetch requests (i.e., having priorities lower than the cache threshold priority) are demoted again to the next lower cache level. Thus, a prefetch can be demoted multiple times through successively lower cache levels until it is accepted or discarded.

At block 617, if no lower level of cache exists in the hierarchy (i.e., the prefetch request 341 was initially targeted to or was demoted to the lowest cache level), then the process 600 continues at block 623. At block 623, the prefetch request is discarded 342 at the lowest cache level (e.g., L3 cache 203), and data is not prefetched based on the request. At block 625, the decision logic 321 discarding the prefetch request 342 indicates the discarded prefetch to the memory controller 520. The memory controller 520 prepares to read the data specified in the discarded prefetch request by, for example, opening the memory page to start the access, as provided at 627. From block 627, the process 600 returns to block 601 to update tags and cache performance metrics.

At a given level of cache 300, the prefetching process 600 repeats for each of multiple prefetch requests that are received at the cache 300. Accordingly, a subset of the prefetch requests having lower priority than the cache threshold priority are demoted to one or more lower cache levels and potentially discarded at the lowest cache level. A subset of the prefetch requests having a higher priority than the cache threshold priority is accepted at the cache 300, and data is prefetched to the cache according to each of the accepted requests. In one embodiment, prefetch requests received while the cache 300 is over-utilized are demoted to a lower-level cache or discarded if the cache 300 is the lowest cache level in the hierarchy. Alternatively, cache resource utilization metrics are used to determine the cache threshold priority level.

A method includes recording a first set of cache performance metrics for a target cache, for each prefetch request of a plurality of prefetch requests received at the target cache, determining based on the first set of cache performance metrics a relative priority of the prefetch request relative to a threshold priority level for the target cache, for each low-priority prefetch request in a first subset of the plurality of prefetch requests, redirecting the low-priority prefetch request to a first lower-level cache in response to determining that a priority of the low-priority prefetch request is less than the threshold priority level for the target cache, and for each high-priority prefetch request in a second subset of the plurality of prefetch requests, storing prefetch data in the target cache according to the high-priority prefetch request in response to determining that a priority of the high-priority prefetch request is greater than the threshold priority level for the target cache.

The method also includes, for each of the low-priority prefetch requests, selecting another cache from a cache hierarchy of the target cache as the first lower-level cache, where the first lower-level cache has a larger capacity than the target cache, and storing prefetch data in the first lower-level cache according to the low-priority prefetch request.

The method also includes, for one or more prefetch requests of the first subset, redirecting the one or more prefetch requests from the first lower level cache to a second lower level cache based a second set of cache performance metrics of the first lower level cache, wherein the second lower level cache has a higher capacity than the first lower level cache.

The method also includes, for one or more prefetch requests in the first subset, redirecting the one or more prefetch requests to a lowest-level cache in the cache hierarchy of the target cache, and discarding the one or more prefetch requests in response to determining that the priority of the one or more prefetch requests is less than a threshold priority level for the lowest-level cache.

The method also includes, for each prefetch request of the plurality of prefetch requests, determining a priority of the prefetch request based on a prefetch accuracy metric. The prefetch accuracy metric is determined based on, for a set of prefetched entries of the target cache, a proportion of unused prefetched entries to used prefetched entries.

The method also includes, for each prefetch request of the plurality of prefetch requests, determining a priority of the prefetch request based on a source of the prefetch request. The source includes one of a hardware prefetcher and a user application.

The method also includes determining the threshold priority level for the target cache based on a cache replacement policy, for each cache entry of a plurality of cache entries in the target cache, an access frequency of the cache entry, and an operation type associated with the cache entry.

In the method, the first set of cache performance metrics includes a victim buffer occupancy metric for a victim buffer of the target cache and a miss request buffer occupancy metric for a miss request buffer of the target cache.

A computing device includes monitoring circuitry for recording a first set of cache performance metrics for a target cache, and a first decision logic circuit coupled with the monitoring circuitry. The first decision logic circuit, for each prefetch request of a plurality of prefetch requests received at the target cache, determines based on the first set of cache performance metrics a relative priority of the prefetch request relative to a threshold priority level for the target cache, for each low-priority prefetch request in a first subset of the plurality of prefetch requests, redirects the low-priority prefetch request to a first lower-level cache in response to determining that the priority of the low-priority prefetch request is less than a threshold priority level for the target cache, and for each high-priority prefetch request in a second subset of the plurality of prefetch requests, stores prefetch data in the target cache according to the high-priority prefetch request in response to determining that the priority of the high-priority prefetch request is greater than the threshold priority level for the target cache.

In the computing device, the first decision logic circuit further, for each of the low-priority prefetch requests, selects another cache from a cache hierarchy of the target cache as the first lower-level cache. The first lower-level cache has a larger capacity than the target cache. The first lower-level cache, for each of the low-priority prefetch requests, stores prefetch data according to the low-priority prefetch request.

The computing device also includes a second decision logic circuit in the first lower-level cache, and a second lower-level cache coupled with the second decision logic circuit and having a higher capacity than the first lower level cache. The second decision logic circuit, for one or more prefetch requests of the first subset, redirects the one or more prefetch requests from the first lower-level cache to the second lower-level cache based a second set of cache performance metrics of the first lower-level cache.

The computing device also includes a lowest-level cache in the cache hierarchy of the target cache, and a second decision logic circuit that, for one or more prefetch requests in the first subset, redirects the one or more prefetch requests to the lowest-level cache, and a third decision logic circuit in the lowest-level cache that discards the one or more prefetch requests in response to determining that the priority of the one or more prefetch requests is less than a threshold priority level for the lowest-level cache.

The computing device also includes a prefetch metrics module coupled with the first decision logic that determines a prefetch accuracy metric based on, for a set of prefetched entries of the target cache, a proportion of unused prefetched entries to used prefetched entries. The first decision logic further, for each prefetch request of the plurality of prefetch requests, determines a priority of the prefetch request based on the prefetch accuracy metric.

The computing device also includes a hardware prefetcher and a processor that generates one or more of the plurality of prefetch requests based on executing instructions of an application. The decision logic further, for each prefetch request of the plurality of prefetch requests, determines a priority of the prefetch request based on a source of the prefetch request. The source includes one of the hardware prefetcher and the processor.

The computing device also includes a cache entry metrics module that records cache entry metrics including, for each cache entry of a plurality of cache entries in the target cache, an access frequency of the cache entry and an operation type associated with the cache entry. The decision logic further determines the threshold priority level based on a cache replacement policy and the cache entry metrics.

A computing system includes a processing unit that executes an application, a plurality of caches in a cache hierarchy coupled with the processing unit, and a cache controller coupled with the plurality of caches. The cache controller includes monitoring circuitry that records a first set of cache performance metrics for a target cache, and a decision logic circuit coupled with the monitoring circuitry. The decision logic circuit, for each prefetch request of a plurality of prefetch requests received at the target cache, determines based on the first set of cache performance metrics a relative priority of the prefetch request relative to a threshold priority level for the target cache, for each low-priority prefetch request in a first subset of the plurality of prefetch requests, redirects the low-priority prefetch request to a first lower-level cache in response to determining that the priority of the low-priority prefetch request is less than a threshold priority level for the target cache, and for each high-priority prefetch request in a second subset of the plurality of prefetch requests, stores prefetch data in the target cache according to the high-priority prefetch request in response to determining that the priority of the high-priority prefetch request is greater than the threshold priority level for the target cache.

The computing system also includes a memory controller coupled with the cache controller. The decision logic circuit further, for one or more prefetch requests in the first subset, redirects the one or more prefetch requests to a lowest-level cache in the cache hierarchy of the target cache, discards the one or more prefetch requests in response to determining that the priority of the one or more prefetch requests is less than a threshold priority level for the lowest-level cache, and transmits an indication of the prefetch request to a memory controller. The memory controller, in response to the indication, initializes an access of the memory containing the prefetch data.

The computing system also includes a hardware prefetcher coupled with the cache hierarchy to generate one or more of the plurality of prefetch requests for the application based on performing branch prediction for the application, and predicting memory accesses based on a pattern of prior memory accesses by the application.

In the computing system, the processing unit further generates one or more of the plurality of prefetch requests according to instructions of the application.

The computing system also includes a plurality of cache controllers including the cache controller. Each of the plurality of cache controllers controls one of the plurality of caches in the cache hierarchy, and redirects one or more of the low-priority prefetch requests in the first subset to another cache in the cache hierarchy having a higher capacity than the associated one of the plurality of caches.

As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a non-transitory computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The non-transitory computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Generally, a data structure representing the computing system 100 and/or portions thereof carried on the computer-readable storage medium may be a database or other data structure which can be read by a program and used, directly or indirectly, to fabricate the hardware including the computing system 100. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist including a list of gates from a synthesis library. The netlist includes a set of gates which also represent the functionality of the hardware including the computing system 100. The netlist may then be placed and routed to produce a data set describing geometric shapes to be applied to masks. The masks may then be used in various semiconductor fabrication steps to produce a semiconductor circuit or circuits corresponding to the computing system 100. Alternatively, the database on the computer-readable storage medium may be the netlist (with or without the synthesis library) or the data set, as desired, or Graphic Data System (GDS) II data.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent and/or alternating manner.

In the foregoing specification, the embodiments have been described with reference to specific exemplary embodiments thereof. It will, however, be evident that various modifications and changes may be made thereto without departing from the broader scope of the embodiments as set forth in the appended claims. The specification and drawings are, accordingly, to be regarded in an illustrative sense rather than a restrictive sense.

1. A method, comprising:
recording a first set of cache performance metrics for a target cache;
for each prefetch request of a plurality of prefetch requests received at the target cache, determining based on the first set of cache performance metrics a relative priority of the prefetch request relative to a threshold priority level for the target cache;
for each low-priority prefetch request in a first subset of the plurality of prefetch requests having a priority that does not exceed the threshold priority level, redirecting the low-priority prefetch request to a first lower-level cache in response to determining that the priority of the low-priority prefetch request does not exceed the threshold priority level; and
for each high-priority prefetch request in a second subset of the plurality of prefetch requests having a priority that exceeds the threshold priority level, storing prefetch data in the target cache according to the high-priority prefetch request in response to determining that the priority of the high-priority prefetch request exceeds the threshold priority level.

2. The method of claim 1, further comprising, for each of the low-priority prefetch requests:
selecting another cache from a cache hierarchy of the target cache as the first lower-level cache, wherein the first lower-level cache has a larger capacity than the target cache; and
storing prefetch data in the first lower-level cache according to the low-priority prefetch request.

3. The method of claim 1, further comprising:
for one or more prefetch requests of the first subset, redirecting the one or more prefetch requests from the first lower level cache to a second lower level cache based a second set of cache performance metrics of the first lower level cache, wherein the second lower level cache has a higher capacity than the first lower level cache.

4. The method of claim 1, further comprising, for one or more prefetch requests in the first subset:
redirecting the one or more prefetch requests to a lowest-level cache in the cache hierarchy of the target cache; and
discarding the one or more prefetch requests in response to determining that the priority of the one or more prefetch requests is less than a threshold priority level for the lowest-level cache.

5. The method of claim 1, further comprising:
for each prefetch request of the plurality of prefetch requests, determining a priority of the prefetch request based on a prefetch accuracy metric, wherein the prefetch accuracy metric is determined based on, for a set of prefetched entries of the target cache, a proportion of unused prefetched entries to used prefetched entries.

6. The method of claim 1, further comprising:
for each prefetch request of the plurality of prefetch requests, determining a priority of the prefetch request based on a source of the prefetch request, wherein the source comprises one of a hardware prefetcher and a user application.

7. The method of claim 1, further comprising determining the threshold priority level for the target cache based on:
a cache replacement policy, and
for each cache entry of a plurality of cache entries in the target cache, an access frequency of the cache entry, and an operation type associated with the cache entry.

8. The method of claim 1, wherein the first set of cache performance metrics comprises a victim buffer occupancy metric for a victim buffer of the target cache and a miss request buffer occupancy metric for a miss request buffer of the target cache.

9. A computing device, comprising:
monitoring circuitry configured to record a first set of cache performance metrics for a target cache;
a first decision logic circuit coupled with the monitoring circuitry and configured to:
for each prefetch request of a plurality of prefetch requests received at the target cache, determine based on the first set of cache performance metrics a relative priority of the prefetch request relative to a threshold priority level for the target cache;
for each low-priority prefetch request in a first subset of the plurality of prefetch requests having a priority that does not exceed the threshold priority level, redirect the low-priority prefetch request to a first lower-level cache in response to determining that the priority of the low-priority prefetch request does not exceed the threshold priority level; and
for each high-priority prefetch request in a second subset of the plurality of prefetch requests having a priority that exceeds the threshold priority level, store prefetch data in the target cache according to the high-priority prefetch request in response to determining that the priority of the high-priority prefetch request exceeds the threshold priority level.

10. The computing device of claim 9, wherein:
the first decision logic circuit is further configured to, for each of the low-priority prefetch requests, select another cache from a cache hierarchy of the target cache as the first lower-level cache,
the first lower-level cache has a larger capacity than the target cache; and
the first lower-level cache is configured to, for each of the low-priority prefetch requests, store prefetch data according to the low-priority prefetch request.

11. The computing device of claim 9, further comprising:
a second decision logic circuit in the first lower-level cache; and
a second lower-level cache coupled with the second decision logic circuit and having a higher capacity than the first lower level cache, wherein:
the second decision logic circuit is configured to, for one or more prefetch requests of the first subset, redirect the one or more prefetch requests from the first lower-level cache to the second lower-level cache based a second set of cache performance metrics of the first lower-level cache.

12. The computing device of claim 9, further comprising:
a lowest-level cache in the cache hierarchy of the target cache; and
a second decision logic circuit configured to, for one or more prefetch requests in the first subset, redirect the one or more prefetch requests to the lowest-level cache; and
a third decision logic circuit in the lowest-level cache configured to discard the one or more prefetch requests in response to determining that the priority of the one or more prefetch requests is less than a threshold priority level for the lowest-level cache.

13. The computing device of claim 9, further comprising:
a prefetch metrics module coupled with the first decision logic and configured to determine a prefetch accuracy metric based on, for a set of prefetched entries of the target cache, a proportion of unused prefetched entries to used prefetched entries,
wherein the first decision logic is further configured to, for each prefetch request of the plurality of prefetch requests, determine a priority of the prefetch request based on the prefetch accuracy metric.

14. The computing device of claim 9, further comprising:
a hardware prefetcher; and
a processor configured to generate one or more of the plurality of prefetch requests based on executing instructions of an application, wherein the decision logic is further configured to, for each prefetch request of the plurality of prefetch requests, determine a priority of the prefetch request based on a source of the prefetch request, wherein the source comprises one of the hardware prefetcher and the processor.

15. The computing device of claim 9, further comprising:
a cache entry metrics module configured to record cache entry metrics comprising, for each cache entry of a plurality of cache entries in the target cache, an access frequency of the cache entry and an operation type associated with the cache entry, wherein the decision logic is further configured to determine the threshold priority level based on a cache replacement policy and the cache entry metrics.

16. A computing system, comprising:
a processing unit configured to execute an application;
a plurality of caches in a cache hierarchy coupled with the processing unit; and
a cache controller coupled with the plurality of caches, the cache controller comprising:
monitoring circuitry configured to record a first set of cache performance metrics for a target cache, and
a decision logic circuit coupled with the monitoring circuitry and configured to:
for each prefetch request of a plurality of prefetch requests received at the target cache, determine based on the first set of cache performance metrics a relative priority of the prefetch request relative to a threshold priority level for the target cache,
for each low-priority prefetch request in a first subset of the plurality of prefetch requests having a priority that does not exceed the threshold priority level, redirect the low-priority prefetch request to a first lower-level cache in response to determining that the priority of the low-priority prefetch request does not exceed the threshold priority level, and
for each high-priority prefetch request in a second subset of the plurality of prefetch requests having a priority that exceeds the threshold priority level, store prefetch data in the target cache according to the high-priority prefetch request in response to determining that the priority of the high-priority prefetch request exceeds the threshold priority level.

17. The computing system of claim 16, further comprising:
a memory controller coupled with the cache controller, wherein the decision logic circuit is further configured to:
for one or more prefetch requests in the first subset, redirect the one or more prefetch requests to a lowest-level cache in the cache hierarchy of the target cache,
discard the one or more prefetch requests in response to determining that the priority of the one or more prefetch requests is less than a threshold priority level for the lowest-level cache, and
transmit an indication of the prefetch request to a memory controller; and
the memory controller is configured to, in response to the indication, initialize an access of the memory containing the prefetch data.

18. The computing system of claim 16, further comprising:
a hardware prefetcher coupled with the cache hierarchy and configured to generate one or more of the plurality of prefetch requests for the application based on:
performing branch prediction for the application, and
predicting memory accesses based on a pattern of prior memory accesses by the application.

19. The computing system of claim 16, wherein:
the processing unit is further configured to generate one or more of the plurality of prefetch requests according to instructions of the application.

20. The computing system of claim 16, further comprising:
a plurality of cache controllers comprising the cache controller, wherein each of the plurality of cache controllers is configured to:
control one of the plurality of caches in the cache hierarchy, and
redirect one or more of the low-priority prefetch requests in the first subset to another cache in the cache hierarchy having a higher capacity than the associated one of the plurality of caches.
